(19) United States
(12) Patent Application Publication
(10) Pub. No.: US 2026/0135229 A1
(43) Pub. Date: May 14, 2026

(54) BATTERY STACKING ASSEMBLY AND BATTERY SYSTEM INCLUDING THE SAME

(71) Applicant: SK On Co., Ltd., Seoul (KR)

(72) Inventors: Ji San KIM, Daejeon (KR); Hae Ryong JEON, Daejeon (KR); Won Tae HEO, Daejeon (KR)

(21) Appl. No.: 19/344,544

(22) Filed: Sep. 30, 2025

(30) Foreign Application Priority Data
Nov. 12, 2024 (KR) 10-2024-0160268

(51) Int. Cl. H01M 50/264; H01M 50/209; H01M 50/242

(52) U.S. Cl. CPC H01M 50/264; H01M 50/209; H01M 50/242

(57) ABSTRACT

The present disclosure relates to a battery stacking assembly, comprising a plurality of battery cells, a first end portion and a second end portion, each of which having a plate shape and disposed at an outermost side of the plurality of battery cells, and a coupling member integrally surrounding the plurality of battery cells, the first end portion, and the second end portion, wherein the coupling member include a first band portion, a second band portion, and a first tie portion and a second tie portion, respectively, disposed opposite to the first end portion and the second end portion and connecting an end of the first band portion and an end of the second band portion and a battery system including the same.

### CROSS-REFERENCE TO RELATED PATENT APPLICATION

The present application claims priority under 35 U.S.C. § 119(a) to Korean patent application number 10-2024-0160268 filed on November 12, 2024, in the Korean Intellectual Property Office, the entire disclosure of which is incorporated herein by reference.

### BACKGROUND OF THE DISCLOSURE

### 1. Field

The present disclosure relates to a battery stacking assembly and battery systems including the same. More specifically, the disclosure relates to a battery stacking assembly and a battery system including the same that improves the life and stability of battery cells.

### 2. Description of the Related Art

Prismatic battery cells may be grouped in a predetermined number to form a battery stacking assembly. Typically, the battery stacking assembly is secured with a strap-like coupling member made of metal to minimize the volume and weight of the battery cells while suppressing swelling of the battery cells. The metallic connecting members may improve the stability of movement of the battery stacking assembly so that it does not shake or scatter due to vibration, and may improve the feasibility of assembly of the battery system. Furthermore, the swelling of the battery cells during charging and discharging may be suppressed and an appropriate surface pressure may be uniformly applied to each battery cell belonging to the battery stacking assembly.

However, since the strap-type coupling member uses a straight strap having a single thickness and width, there is a problem that a weak part is broken due to localized stretching, and since a pair of coupling members are provided side by side at the top and bottom, respectively, there is a problem of unnecessary volume increase and a decrease in the energy density of the battery cell.

According to one aspect of the present disclosure, it is directed to improve the structural stability of a battery stacking assembly and/or battery systems.

According to another aspect of the present disclosure, it is directed to extend the lifetime of a battery stacking assembly and/or battery system.

According to another aspect of the present disclosure, it is directed to effectively suppress swelling of battery cells.

According to another aspect of the present disclosure, it is directed to minimize the weight and/or volume increase of a battery stacking assembly and/or battery system.

According to another aspect of the present disclosure, it is directed to maximize the energy density of a battery stacking assembly and/or battery system.

According to another aspect of the present disclosure, it is directed to prevent fracture of the coupling members.

The battery stacking assembly and battery system including the same according to the present disclosure may be widely applied in the field of green technology, such as electric vehicles, battery charging stations, energy storage systems, and other applications utilizing batteries, such as photovoltaics and wind power. Furthermore, the battery stacking assembly and the battery system comprising the battery according to the present disclosure may be used in eco-friendly mobility, including electric vehicles and hybrid vehicles to prevent climate change by suppressing air pollution and greenhouse fluid emissions.

### SUMMARY OF THE DISCLOSURE

A battery stacking assembly according to the present disclosure may comprise: a plurality of battery cells arranged along a predetermined stacking direction; a first end portion and a second end portion, each of which having a plate shape and disposed at an outermost side of the plurality of battery cells along the stacking direction; and a coupling member integrally surrounding the plurality of battery cells, the first end portion, and the second end portion; wherein the coupling member may include: a first band portion extending along the stacking direction at a predetermined first height along the height direction of the plurality of battery cells; a second band portion extending along the stacking direction at a second height lower than the first height along the height direction of the plurality of battery cells; and a first tie portion and a second tie portion, respectively, disposed opposite to the first end portion and the second end portion and connecting an end of the first band portion and an end of the second band portion; and the plurality of battery cells may be disposed between the first band portion and the second band portion.

In an embodiment, the first end portion may include: a contact surface, which is an outermost surface of the first end portion along the stacking direction; a first side surface and a second side surface forming two side surfaces along a width direction perpendicular to the stacking direction and the height direction and contacting the first band portion and the second band portion, respectively; and a top surface forming a top of the first end portion.

In an embodiment, a length of each of the plurality of battery cells along the width direction may be less than or equal to a length of the first end portion.

In an embodiment, the first end portion may include: a contact groove formed of a groove corresponding to a shape of the first tie portion on the contact surface for insertion of the first tie portion; a first side groove formed of a groove corresponding to a shape of the first band portion and recessed along the width direction on the first side surface for insertion of the first band portion; and a second side groove formed of a groove corresponding to a shape of the second band portion and recessed along the width direction on the second side surface for insertion of the second band portion.

In an embodiment, the first band portion may include: a first band connection portion positioned on the first side surface and extending along the stacking direction; and a first band reinforcement portion positioned on the top surface, connected to the first band connection portion, surrounding an edge of the first end portion and extending along the stacking direction; and the first tie portion may include: a first tie connection portion connected to the first band connection portion; and a first tie reinforcement portion connected to the first tie connection portion and the first band reinforcement portion.

In an embodiment, a length of the first band portion may be different from a length of the second band portion along the height direction.

In an embodiment, the first band reinforcement portion may be welded with the first band connection portion, and the first tie reinforcement portion may be welded with the first band reinforcement.

In an embodiment, the first end portion may further include: a contact groove formed of a groove corresponding to a shape of the first tie portion on the contact surface for insertion of the first tie portion; a first side groove formed of a groove corresponding to a shape of the first band connection portion and recessed along the width direction on the first side surface for insertion of the first band connection portion; a first top-side groove formed of a groove corresponding to a shape of the first band reinforcement portion on the top surface, recessed along the height direction, and connected to the first side groove for insertion of the first band reinforcement portion; and a second side groove formed of a groove corresponding to a shape of the second band portion and recessed along the width direction on the second side surface for insertion of the second band portion.

In an embodiment, the first end portion may further include: a first symmetrical groove formed on the first side surface with the same shape as the second side groove at a position corresponding to the second side groove; a second symmetrical groove formed on the second side surface with the same shape as the first side groove at a position corresponding to the first side groove; and a second top-side groove formed on the top surface with the same shape as the first top-side groove and connected to the second symmetrical groove.

In an embodiment, the first band portion may include: a first band connection portion positioned on the first side surface and extending along the stacking direction; and a first band auxiliary portion positioned on the top surface and connected to the first band connection portion at a predetermined connection length along the stacking direction; and the first tie portion may include: a first tie connection portion connected to the first band connection portion; and a first tie auxiliary portion connected to the first band auxiliary portion and the first tie connection portion.

In an embodiment, the first tie auxiliary portion may be welded with the first band auxiliary portion.

In an embodiment, the first band portion may include: a first band connection portion positioned on the first side surface and extending along the stacking direction; and a first band reinforcement portion positioned on the top surface, connected to the first band connection portion, surrounding an edge of the first end portion, and extending along the stacking direction; and the first tie portion may include: a first tie connection portion connected to the first band connection portion; and a first tie auxiliary portion connected to the first band reinforcement portion and the first tie connection portion.

In an embodiment, the first tie auxiliary portion may be welded with the first band reinforcement portion.

In an embodiment, the second band portion may be in contact from the second height to a predetermined height along the height direction.

In an embodiment, the second height may be the lowermost end of the second side surface.

In an embodiment, the coupling member may further include: a first strap spaced apart from a bottom of the first band portion and extending along the stacking direction; a second strap spaced apart from the top portion of the second band portion and extending along the stacking direction; a first intersecting connection portion contacting the first end portion, connecting an end of the first strap to an end of the second strap, and intersecting the first tie portion; and a second intersecting connection portion contacting the second end portion, connecting the other end of the first strap to the other end of the second strap, and intersecting the second tie portion.

A battery system according to the present disclosure may comprise: a first battery stacking assembly and a second battery stacking assembly, respectively, including a plurality of battery cells arranged along a predetermined stacking direction, a first end portion and a second end portion, each of which having a plate shape and disposed at an outermost side of the plurality of battery cells along the stacking direction, and a first coupling member and a second coupling member integrally surrounding the plurality of battery cells, the first end portion, and the second end portion; and the first coupling member and the second coupling member, respectively, may include: a first band portion extending along the stacking direction at a predetermined first height along the height direction of the plurality of battery cells; a second band portion extending along the stacking direction at a second height lower than the first height along the height direction of the plurality of battery cells; and a first tie portion and a second tie portion, respectively, disposed opposite to the first end portion and the second end portion and connecting an end of the first band portion and an end of the second band portion; and the first battery stacking assembly and the second battery stacking assembly may be arranged along a width direction perpendicular to the stacking direction and the height direction, and at least a portion of the first band portion of the first battery stacking assembly and the second band portion of the second battery stacking assembly are positioned to overlap each other.

In another embodiment, the battery system may further comprise: an insertion inserted between the first band portion of the first battery stacking assembly and the second band portion of the second battery stacking assembly along the height direction.

In another embodiment, a gap between the first battery stacking assembly and the second battery stacking assembly may be less than the sum of thicknesses of the first band portion of the first battery stacking assembly and the second band portion of the second battery stacking assembly along the width direction.

In another embodiment, each of the plurality of battery cells may include a case accommodating an electrode assembly therein, and the sum of lengths of the first band portion of the first battery stacking assembly and the second band portion of the second battery stacking assembly or the sum of lengths of the second band portion of the first battery stacking assembly and the first band portion of the second battery stacking assembly may be less than or equal to half the height of the case along the height direction.

According to one embodiment of the present disclosure, the structural stability of a battery stacking assembly and/or a battery system may be improved.

According to another embodiment of the present disclosure, the lifetime of a battery stacking assembly and/or a battery system may be extended.

According to another embodiment of the present disclosure, the swelling of battery cells may be effectively suppressed.

According to another embodiment of the present disclosure, the weight and/or volume increase of a battery stacking assembly and/or battery system may be minimized.

According to another embodiment of the present disclosure, the energy density of the battery stacking assembly and/or battery system may be maximized.

According to another embodiment of the present disclosure, the breakage of the coupling member may be prevented.

### BRIEF DESCRIPTION OF THE DRAWINGS

FIG. 1 illustrates an example of a battery stacking assembly according to the present disclosure.

FIG. 2 illustrates an example of a coupling member according to the present disclosure.

FIG. 3 is a front view of a first end portion of a battery stacking assembly according to the present disclosure.

FIG. 4 is a front view of an example of the first end portion according to the present disclosure.

FIG. 5 illustrates another example of a battery stacking assembly according to the present disclosure.

FIG. 6 is a planar figure of another example of a coupling member according to the present disclosure.

FIG. 7 is a front view of another example of a first end portion according to the present disclosure.

FIG. 8 is a planar figure of another example of a coupling member according to the present disclosure.

FIG. 9 is a planar figure of another example of a coupling member according to the present disclosure.

FIG. 10 is a planar figure of another example of a coupling member according to the present disclosure.

FIG. 11 illustrates another example of a battery stacking assembly according to the present disclosure.

FIG. 12 illustrates another example of a battery system according to the present disclosure.

### DETAILED DESCRIPTION

Hereinafter, preferred embodiments of the present disclosure will be described in detail with reference to the accompanying drawings. The configuration of the apparatus or control method described below is for the purpose of illustrating embodiments of the present disclosure and is not intended to limit the scope of the present disclosure, and the same reference numerals used throughout the specification refer to the same components.

The use of terms such as "first," "second," "third," and the like to precede components referred to herein is intended to avoid confusion as to the components to which they refer, and is not intended to indicate any order, importance, or master-servant relationship among the components. For example, it is possible to practice an invention comprising only the second component without the first component.

As used herein, the singular expression includes the plural unless the context clearly indicates otherwise.

As used herein, a battery stacking assembly may refer to a battery assembly comprising a plurality of battery cells grouped together and arranged along a predetermined stacking direction. For example, the battery assembly may refer to a battery module.

Further, in the present disclosure, a battery system may refer to any one of a battery pack and an energy storage system including a plurality of battery stacking assemblies, i.e., the plurality of battery stacking assemblies may form a single battery system.

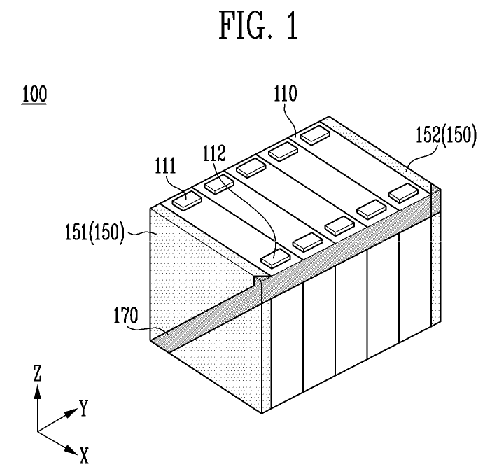

FIG. 1 illustrates an example of a battery stacking assembly according to the present disclosure.

The battery stacking assembly 100 according to the present disclosure may include a plurality of battery cells 110 arranged along a predetermined stacking direction, a first end portion 151 and a second end portion 152, each of which having a plate shape and disposed at an outermost side of the plurality of battery cells 110 along the stacking direction; and a coupling member 170 integrally surrounding the plurality of battery cells 110, the first end portion 151, and the second end portion 152, wherein the coupling member 170 may include a first band portion 173 extending along the stacking direction at a predetermined first height along the height direction of the plurality of battery cells, a second band portion 174 extending along the stacking direction at a second height lower than the first height along the height direction of the plurality of battery cells, and a first tie portion 171 and a second tie portion 172, respectively, disposed opposite to the first end portion 151 and the second end portion 152 and connecting an end of the first band portion 173 and an end of the second band portion 174, wherein the plurality of battery cells 110 may be disposed between the first band portion 173 and the second band portion 174.

For example, the battery stacking assembly 100 may include a plurality of battery cells 110 arranged along a predetermined stacking direction, a first end portion 151 and a second end portion 152, each having a plate shaped and disposed at an outermost side of the plurality of battery cells 110 along the stacking direction (or Y-direction), and a coupling member 170 integrally surrounding the plurality of battery cells 110, the first end portion 151 and the second end portion 152.

The shape of the battery cells 110 may be prismatic battery cells. However, the shape of the battery cell 110 is not limited to this, and other shapes of the battery cell 110 may be acceptable as long as the battery cell 110 is capable of being bundled via the coupling member 170.

The battery cell 110 may include a case 115 (not shown) accommodating an electrode assembly (not shown) therein, and terminal portions 111, 112 protruding outwardly from the case 115 in connection with the electrode assembly.

The battery stacking assembly 100 may include an end portion 150 disposed at an outermost side of the plurality of battery cells 110, along a stacking direction of the plurality of battery cells 110. The end portion 150 may include a first end portion 151 disposed at a front side F of the plurality of battery cells 110 and a second end portion 152 disposed at a rear side R of the plurality of battery cells 110.

Further, the battery stacking assembly 100 may include a coupling member 170 to prevent swelling of the plurality of battery cells 110 and to prevent rocking of the plurality of battery cells 110.

The coupling member 170 may be inclined diagonally to the first end portion 151 and/or the second end portion 152 when viewing the first end portion 151.

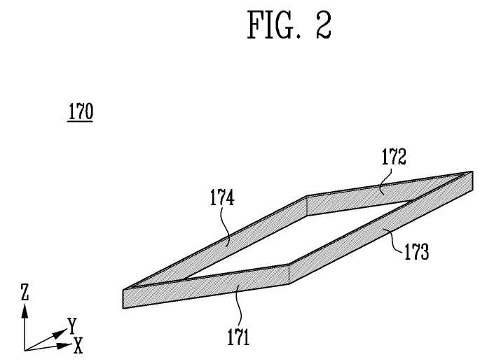

FIG. 2 illustrates an example of a coupling member according to the present disclosure.

The coupling member 170 may include a first band portion 173 and a second band portion 174 extending along the stacking direction, and may include a first tie portion 171 and a second tie portion 172 electrically connected to the first band portion 173 and the second band portion 174.

The first band portion 173 and the second band portion 174 may be disposed at different heights along a height direction of the plurality of battery cells and/or a height direction (Z-direction) of the first end portion 151.

In other words, referring to FIGS. 1 and 2, the battery stacking assembly 100 according to the present disclosure may include a plurality of battery cells 110 disposed along a predetermined stacking direction, a plate shaped first end portions 151 and a plate shaped second end portions 152 disposed on the outermost sides of the plurality of battery cells 110 along the stacking direction, and a coupling member 170 integrally surrounding the plurality of battery cells 110, the first end portions 151 and the second end portions 152.

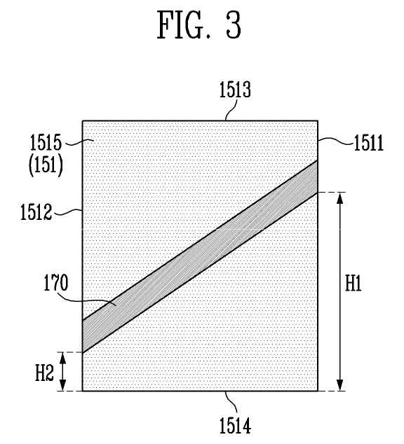

Further, referring to FIG. 3, the coupling member 170 may include a first band portion 173 extending along the stacking direction at a predetermined first height H1 along the height direction of the plurality of battery cells 110, the plurality of battery cells 110 being disposed between the first band portion 173, and a second height H2 lower than the first height H1 along the height direction of the plurality of battery cells 110, a second band portion 174 extending along the stacking direction at a second height H2 lower than the first height H1, and a first tie portion 171 and a second tie portion 172 connecting one end of the first band portion 173 and one end of the second band portion 174 disposed opposite to the first end portion 151 and the second end portion 152, respectively.

Thus, the plurality of battery cells 110 may be disposed between the first band portion 173 and the second band portion 174.

Further, the plurality of battery cells 110 may be disposed between the first tie portion 171 and the second tie portion 172.

Further, the coupling member 170 may be configured in the shape of a square ring. And, the coupling member 170 may have four corners of the square ring shape rounded.

FIG. 3 is a front view of the first end portion 171 of a battery stacking assembly according to the present disclosure.

Specifically, FIG. 3 shows the first tie portion 171 and the contact surface 1515, which is the front of the first end portion 151.

According to present disclosure, the first end portion 151 may include a contact surface 1515, which is an outermost surface of the first end portion 151 along the stacking direction, a first side surface 1511 and a second side surface 1512 forming two side surfaces along a width direction perpendicular to the stacking direction and the height direction and contacting the first band portion 173 and the second band portion 174, respectively, and a top surface 1513 forming a top of the first end portion 151.

For example, the first end portion 151 may be configured in a plate shape. Referring to FIG. 1, the plate shape may mean a shape in which the length of the first end portion 151 along the stacking direction (Y direction) is less than the length of the first end portion 151 along the width direction (X direction) and the height direction (Z direction).

The first end portion 151 may include a contact surface 1515 that is an outermost side of the first end portion 151 along the stacking direction, a first side surface 1511 and a second side surface 1512 that form two side surfaces along a width direction perpendicular to the stacking direction and the height direction and that are in contact with the first band portion 173 and the second band portion 174, respectively, and a top surface 1513 that forms a top of the first end portion 151.

The contact surface 1515 may contact the first tie portion 171 and form a front face of the first end portion 151.

The first side surface 1511 and the second side surface 1512 may contact the first band portion 173 and the second band portion 174, respectively, and the first tie portion 171 may be connected to the first band portion 173 and the second band portion 174, respectively, at an edge where the first side surface 1511 and the contact surface 1515 meet and at an edge where the second side surface 1512 and the contact surface 1515 meet.

Further, the first end portion 151 may further comprise a bottom surface 1514 located opposite the top surface 1513 and forming a bottom surface of the first end portion 151.

Meanwhile, the first band portion 173 and the second band portion 174 may be disposed at different heights along the height direction. Accordingly, the first tie portion 171 connecting the first band portion 173 and the second band portion 174 may be inclined.

The second tie portion 172 may also be inclined as the first tie portion 171.

The inclination angle and inclination direction of the first tie portion 171 and the second tie portion 172 may vary depending on the height of the first band portion 173 and the second band portion 174. For example, the height of the second band portion 174 may be higher than the height of the first band portion 173 such that the inclination direction of the first tie portion 171 is opposite to that shown in FIG. 3.

On the other hand, the first band portion 173 may be located at a predetermined first height H1 and the second band portion 174 may be located at a second height H2. Considering the lengths or widths of the first band portion 173 and the second band portion 174 along the height direction, the first height H1 and the second height H2 may be the lengths to the bottom of the first band portion 173 and the bottom of the second band portion 174, respectively, relative to the bottom surface 1514.

Unless otherwise noted in the present disclosure, the first end portion 151 and the second end portion 152 have the same form and function, so that the description of the first end portion 151 may be equally applicable to the second end portion 152.

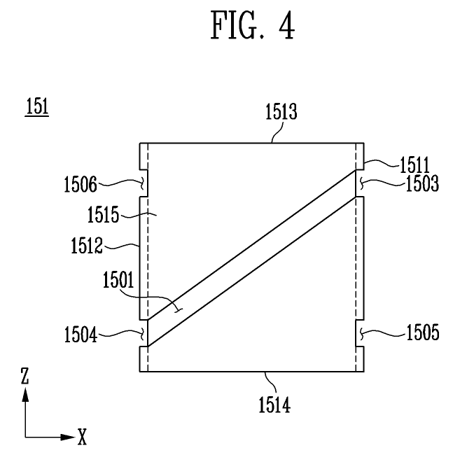

FIG. 4 is a front view of an example of the first end portion 151 according to the present disclosure.

The coupling member 170 may bind the plurality of battery cells 110, the first end portion 151 and the second end portion 152 together.

Unlike conventional coupling members, a moment may be applied to the coupling member 170 since the first tie portion 171 and the second tie portion 172 connect the first band portion 173 and the second band portion 174 at an inclined angle to the first band portion 173 and the second band portion 174. In order to prevent the coupling member 170 from being pulled out by an external force, and to guide the coupling member 170 to be coupled to the plurality of battery cells 110, the first end portion 151 and the second end portion 152, the first end portion 151 may include a groove into which the coupling member 170 is inserted. In other words, the groove formed in the first end portion 151 may improve the fixity and assemblability of the coupling member 170.

According to the present disclosure, the first end portion 151 may include a contact groove 1501 formed of a groove corresponding to a shape of the first tie portion 171 on the contact surface for insertion of the first tie portion 171, a first side groove 1503 formed of a groove corresponding to a shape of the first band portion 173 and being recessed along the width direction on the first side surface 1511 for insertion of the first band portion 173, and a second side groove 1504 formed of a groove corresponding to a shape of the second band portion 174 and being recessed along the width direction on the second side surface 1512 for insertion of the second band portion 174.

For example, the first end portion 151 may include a contact groove 1501 formed in the form of a groove corresponding to the shape of the first tie portion 171 at the contact surface 1515 for insertion of the first tie portion 171.

It may further include a first side groove 1503 formed in the form of a recessed groove along the width direction corresponding to the shape of the first band portion 173 at the first side surface 1511 for insertion of the first band portion 173, and a second side groove 1504 formed in the form of a recessed groove along the width direction corresponding to the shape of the second band portion 174 at the second side surface 1512 for insertion of the second band portion 174.

The contact groove 1501 may receive at least a portion of the first tie portion 171 along the stacking direction. To this end, the contact groove 1501 may be configured in the contact surface 1515 to correspond to an inclined shape of the first tie portion 171.

The depth of the contact groove 1501 may be greater than or equal to the thickness of the first tie portion 171. This is to prevent the thickness of the first tie portion 171 from lengthening the length of the battery stacking assembly 100 along the stacking direction. Similarly, the depth of the contact groove 1501 of the second end portion 152 may be greater than or equal to the thickness of the second tie portion 172.

The first side groove 1503 and the second side groove 1504 may be formed at a height corresponding to the first band portion 173 and the second band portion 174, respectively, i.e., a lower end of the first side groove 1503 may be at the first height H1, and a lower end of the second side groove 1504 may be at the second height H2.

For example, along the height direction, a height of a top of the first band portion 173 relative to the bottom surface 1514 may be a height of a corner where the top surface 1513 and the first side surface 1511 meet. And, along the height direction, the second height H2 may correspond to the height of the corner where the bottom surface 1514 and the second side surface 1512 meet, i.e., the second height H2 may be zero.

For example, the first end portion 151 may further include a first symmetrical groove 1505 formed in the same shape at a position corresponding to the second symmetrical groove 1504 at the first side surface 1511 and a second symmetrical groove 1506 formed in the same shape at a position corresponding to the first symmetrical groove 1503 at the second side surface 1512.

The first symmetrical groove 1505 and the second side groove 1504 may also be formed with the same shape at the second height H2, and the second symmetrical groove 1506 and the first side groove 1503 may be formed with the same shape at the first height H1.

Since the first end portion 151 and the second end portion 152 are of the same shape, so the first end portion 151 and the second end portion 152 may be used without distinguishing between them during assembly. Furthermore, when the battery stacking assembly 100 are arranged along the width direction in a plurality of battery stacking assembly 100, it is to prevent interference along the width direction between neighboring battery stacking assembly 100 due to the first band portion 173 and the second band portion 174, respectively.

On the other hand, the first band portion 173 and the second band portion 174 may be received in the first side groove 1503 and the second side groove 1504, respectively, to contact the sides of the plurality of battery cells 110. Thus, the length of the plurality of battery cells 110 along the width direction may be less than or equal to the length of the first end portion 151.

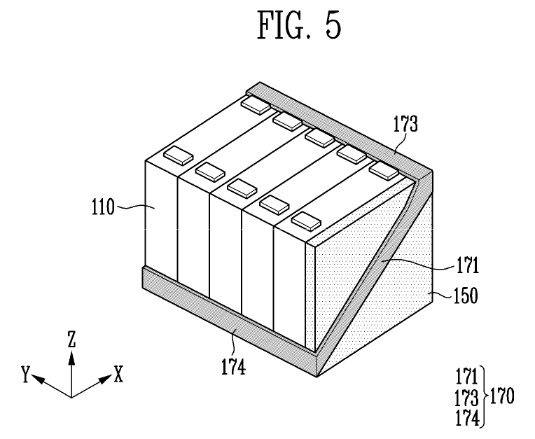

FIG. 5 illustrates another example of a battery stacking assembly according to the present disclosure.

In consideration of the stress distribution of the coupling member 170, stresses may be concentrated in the region where the first band portion 173 and the first tie portion 171 meet, and in the region where the second band portion 174 and the first tie portion 171 meet.

Similarly, stresses may be concentrated in the region where the first band portion 173 meets the second tie portion 172, and in the region where the second band portion 174 meets the second tie portion 172.

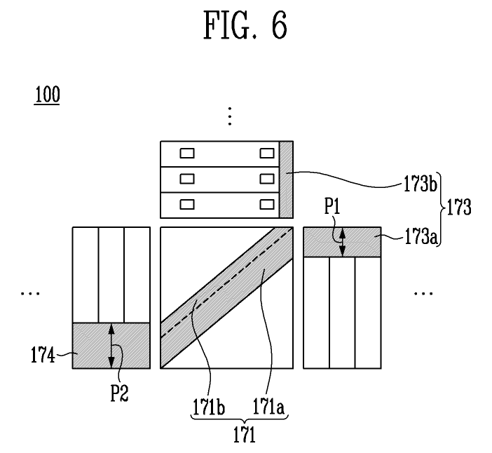

The battery stacking assembly 100 according to the present disclosure may include additional stiffening structures to increase the stiffness of the coupling member 170 relative to the concentrated stresses. FIGS. 6 and 8 to 10 illustrate various examples of the stiffening structures. Furthermore, the stiffening structures are not limited to the various embodiments described in FIGS. 6 and 8 to 10, but may be varied, i.e., variations in the form and location of the stiffening structures may be self-evident to those of ordinary skill in the battery field.

FIG. 6 is a planar figure of another example of a coupling member according to the present disclosure.

FIGS. 6 and 8 to 10 utilize planar figures to illustrate the coupling member 170. To illustrate the coupling member 170, the battery cell 110 is also shown in a schematic unfolded view. However, the first end portion 151 is not shown.

According to the present disclosure, the first band portion 173 may include a first band connection portion 173a positioned on the first side surface 1511 and extending along the stacking direction, and a first band reinforcement portion 173b positioned on the top surface 1513, connected to the first band connection portion 173a, surrounding an edge of the first end portion 151 and extending along the stacking direction, and the first tie portion 171 may include a first tie connection portion 171a connected to the first band connection portion 173a and a first tie reinforcement portion 173b connected to the first tie connection portion 171a and the first band reinforcement portion 173b.

For example, referring to FIG. 6, the first band portion 173 may include a first band connection portion 173a located at the first side surface 1511 and extending along the stacking direction, and a first band reinforcement portion 173b located at the top surface 1513 and connected to the first band connection portion 173a, surrounding around an edge of the first end portion 151 and extending along the stacking direction.

That is, the first band connection portion 173a and the first band reinforcement portion 173b may be bent or L-shaped in cross-section to surround the edge where the top surface 1513 and the first side surface 1511 meet.

Further, the first tie portion 171 may include a first tie connection portion 171a connecting with the first band connection portion 173a, and a first tie reinforcement portion 171b connecting with the first tie connection portion 171a and the first band reinforcement portion 173b.

From a stress distribution point of view, the vulnerable part of the coupling member 170 is the area where the contact surface 1515, the first side surface 1511 and the top surface 1513 meet, so that the first tie connection part 173a, the first tie reinforcement part 173b, and the first tie reinforcement part 173b are more vulnerable, the first tie connection portion 171a, and the first tie reinforcement portion 171b may be connected to each other in a form that surrounds the region where the contact surface 1515, the first side surface 1511, and the top surface 1513 meet.

According to the present disclosure, the first band reinforcement portion 173b may be welded with the first band connection portion 173a, and the first tie reinforcement portion 171b may be welded with the first band reinforcement 173b.

For example, the first band reinforcement portion 173b may be welded with the first band connection portion 173a to surround an edge where the top surface 1513 and the first side surface 1511 meet.

For example, the first tie reinforcement portion 171b may be welded with the first band reinforcement portion 173b.

For example, the coupling member 170 may be press molded from a single sheet without any welded connections.

Considering that the first tie connection portion 171a and the first tie reinforcement portion 171b are connected with the second band portion 174, and the first tie connection portion 171a is connected with the first band connection portion 173a, the length P1 of the first band portion 173 along the height direction may be different from the length P2 of the second band portion 174.

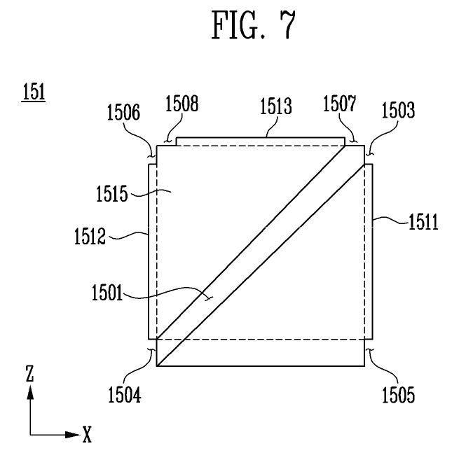

FIG. 7 is a front view of another example of a first end portion according to the present disclosure.

As mentioned above, in order to prevent the coupling member 170 from being dislodged by external forces and to guide the coupling member 170 to be coupled to the plurality of battery cells 110, the first end portion 151 and the second end portion 152, the first end portion 151 may include a groove into which the coupling member 170 is inserted. In other words, the groove formed in the first end portion 151 may improve the fixity and assemblability of the coupling member 170.

To this end, the first end portion 151 may include a contact groove 1501 formed in the form of a groove corresponding to the shape of the first tie portion 171 at the contact surface 1515 for insertion of the first tie portion 171.

Further, the first end portion 151 may include a first side groove 1503 formed in the form of a recess along the width direction corresponding to the shape of the first band connection portion 173a at the first side surface 1511 for insertion of the first band connection portion 173a, and a first top-side groove 1507, which is in the form of a recess along the height direction corresponding to the shape of the first band reinforcement portion 173b at the top surface 1513 for insertion of the first band reinforcement portion 173b, and which connects with the first side groove 1503.

Further, the first end portion 151 may further comprise a second side groove 1504 in the form of a recess along the width direction corresponding to the shape of the second band portion 174 at the second side surface 1512 for insertion of the second band portion 174.

The first side groove 1503 and the first top-side groove 1507 may be connected to each other to form an L-shaped groove.

According to the present disclosure, the first end portion 151 may further include a first symmetrical groove 1505 formed on the first side surface 1511 with the same shape as the second side groove 1504 at a position corresponding to a second side groove 1504, a second symmetrical groove 1506 formed on the second side surface 1512 with the same shape as the first side groove 1503 at a position corresponding to the first side groove 1503, and a second top-side groove formed on the top surface with the same shape as a first top-side groove and connected to the second symmetrical groove 1506.

Meanwhile, the first end portion 151 may include a first symmetrical groove 1505 formed in the same shape at a position corresponding to the second symmetrical groove 1504 at the first side surface 1511, and a second symmetrical groove 1506 formed in the same shape at a position corresponding to the first symmetrical groove 1503 at the second side surface 1512.

Further, the first end portion 151 may further comprise a second top-side groove 1508 formed in the same shape as the first top-side groove 1507 at the top surface 1513 and connecting with the second symmetrical groove 1506.

The second symmetrical groove 1506 and the second top-side groove 1508 may be connected to each other to form an L-shaped groove.

Since the first end portion 151 and the second end portion 152 are of the same shape, the first end portion 151 and the second end portion 152 may be used without distinguishing between them during assembly. Furthermore, when the battery stacking assembly 100 are arranged along the width direction in a plurality of battery stacking assembly 100, it is to prevent interference along the width direction between neighboring battery stacking assembly 100 due to the first band portion 173 and the second band portion 174, respectively.

On the other hand, the first symmetrical groove 1505 and the second side groove 1504 may be rounded to prevent breakage of the coupling member.

Similarly, the first side groove 1503 and the second symmetrical groove 1506 may also be rounded.

Additionally, the first top-side groove 1507 and the second top-side groove 1508 may also be rounded.

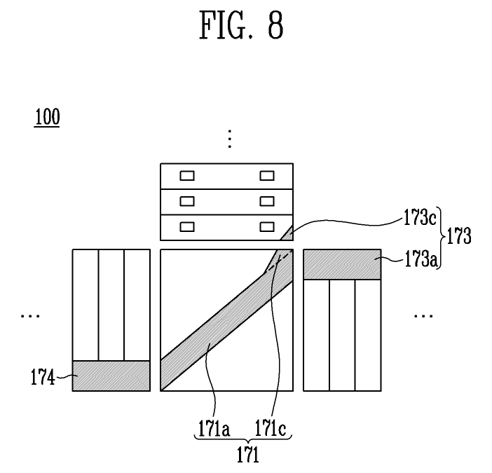

FIG. 8 is a planar figure of another example of a coupling member according to the present disclosure.

According to the present disclosure, the first band portion 173 may include a first band connection portion 173a positioned on the first side surface 1511 and extending along the stacking direction, and a first band auxiliary portion 173c positioned on the top surface 1513 and connected to the first band connection portion 173a at a predetermined connection length along the stacking direction, and the first tie portion 171 may include a first tie connection portion 171a connected to the first band connection portion 173a, and a first tie auxiliary portion 173c connected to the first band auxiliary portion 173c and the first tie connection portion 171a.

For example, the first band portion 173 includes a first band connection portion 173a located at the first side surface 1511 and extending along the stacking direction, and a first band auxiliary portion 173c located at the top surface 1513 and connecting with the first band connection portion 173a at a predetermined connection length along the stacking direction, wherein the first tie portion 171 may include a first tie connection portion 171a connecting with the first band connection portion 173a, and a first tie auxiliary portion 173c connecting with the first tie connection portion 171a and the first band auxiliary portion 173c connecting with the first tie connection portion 171a.

From a stress distribution perspective, the vulnerable portion of the coupling member 170 is the region where the contact surface 1515, the first side surface 1511, and the top surface 1513 meet, and therefore, the first band connection portion 173a, the first band auxiliary portion 173c, the first tie connection portion 171a, and the first tie auxiliary portion 171c may be connected to each other in a form that encloses the region where the contact surface 1515, the first side surface 1511, and the top surface 1513 meet.

To this end, the first tie auxiliary portion 171c may be welded with the first band auxiliary portion 173c. Alternatively, the joining member 170 may be cut from a single sheet and then bent and molded.

For example, the first tie auxiliary portion 171c and the first band auxiliary portion 173c may be a triangular-shaped sheet.

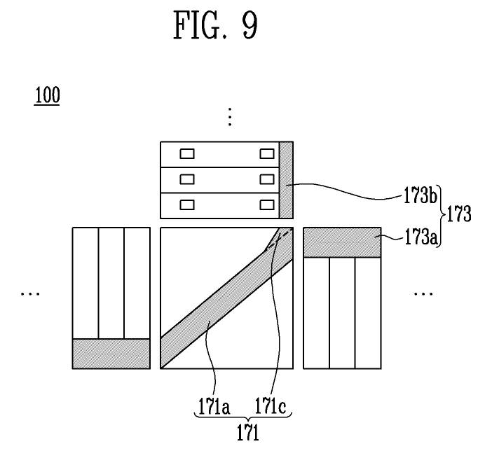

FIG. 9 is a planar figure of another example of a coupling member according to the present disclosure.

According to the present disclosure, the first band portion 173 may include a first band connection portion 173a positioned on the first side surface 1511 and extending along the stacking direction, and a first band reinforcement portion 173b positioned on the top surface 1513, connected to the first band connection portion 173a, surrounding an edge of the first end portion 151, and extending along the stacking direction, and the first tie portion 171 may include a first tie connection portion 171a connected to the first band connection portion 173a, and a first tie auxiliary portion 171c connected to the first band reinforcement portion 173b and the first tie connection portion 171a.

For example, the first band portion 173 may include a first band connection portion 173a located at the first side surface 1511 and extending along the stacking direction, and a first band reinforcement portion 173b located at the top surface 1513 and connected to the first band connection portion 173a to surround an edge of the first end portion 151, extending along the stacking direction, wherein the first tie portion 171 may include a first tie connection portion 171a connecting with the first band connection portion 173a, and a first tie auxiliary portion 171c connecting with the first band reinforcement portion 173b and the first tie connection portion 171a.

From a stress distribution point of view, the vulnerable part of the coupling member 170 is the region where the contact surface 1515, the first side surface 1511 and the top surface 1513 meet, and therefore the first band connection part 173a, the first band reinforcement part 173b, the first tie connection portion 171a, and the first tie auxiliary portion 171c may be connected to each other in a form that encloses the region where the contact surface 1515, the first side surface 1511, and the top surface 1513 meet.

To this end, the first tie auxiliary portion 171c may be welded with the first band reinforcement portion 173b. Alternatively, the coupling member 170 may be cut from a single sheet and then bent and molded.

For example, the first tie auxiliary portion 171c may be a triangular-shaped sheet, while the first band reinforcement portion 173b may be a strip-shaped sheet.

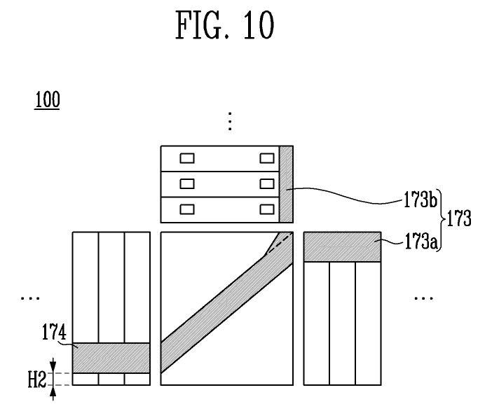

FIG. 10 is a planar figure of another example of a coupling member according to the present disclosure.

The second band portion 174 may be in contact along the height direction from the second height H2 to a predetermined height.

The length from the second height H2 to the predetermined height may be a width of the second band portion 174.

Referring to FIG. 10, the second height H2 is shown in one example spaced apart from the bottom surface 1514. Alternatively, the second height H2 may be absent, i.e., the second height H2 may be the lowermost end of the second side surface 1512. In other words, the second band portion 174 may cover the first end portion 151, the plurality of battery cells 110, and the second end portion 152 from the bottom of the second side surface 1512 to the predetermined height.

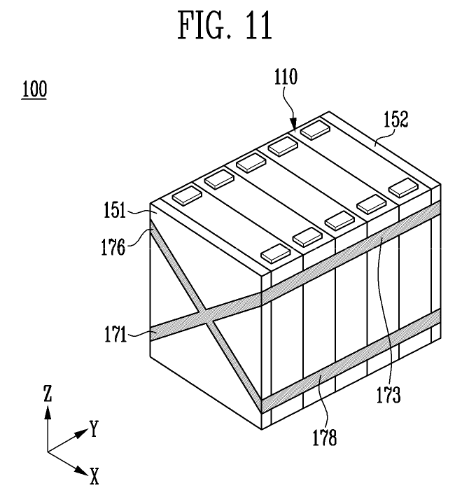

FIG. 11 illustrates another example of a battery stacking assembly according to the present disclosure.

In order to distribute stresses on the coupling member 170, the coupling member 170 may include a first strap 178 extending along the stacking direction at the second height H2 in parallel with the first band portion 173, and a second strap (not shown) extending along the stacking direction at the first height H1 in parallel with the second band portion 174, and a first intersecting connection portion 176 and a second intersecting connection portion (not shown) connecting the first strap 178 and the second strap and intersecting the first tie portion 171 and the second tie portion 172, respectively.

According to the present disclosure, the coupling member 170 may further include a first strap 178 spaced apart from a bottom of the first band portion 173 and extending along the stacking direction, a second strap spaced apart from the top portion of the second band portion 174 and extending along the stacking direction, a first intersecting connection portion 176 contacting the first end portion 151, connecting an end of the first strap 178 to an end of the second strap, and intersecting the first tie portion 171, and a second intersecting connection portion contacting the second end portion 152, connecting the other end of the first strap 178 to the other end of the second strap, and intersecting the second tie portion 172.

For example, the coupling member 170 may include a first strap 178 spaced apart at the lower end of the first band portion 173 and extending along the stacking direction, and a second strap (not shown) spaced apart at the upper end of the second band portion 174 and extending along the stacking direction. It may further include a first intersecting connection portion 176 in contact with the first end portion 151, connecting one end of the first strap 178 to one end of the second strap and intersecting the first tie portion 171, and a second intersecting connection portion (not shown) in contact with the second end portion 152, connecting one end of the first strap 178 to the other end of the second strap and intersecting the second tie portion 172.

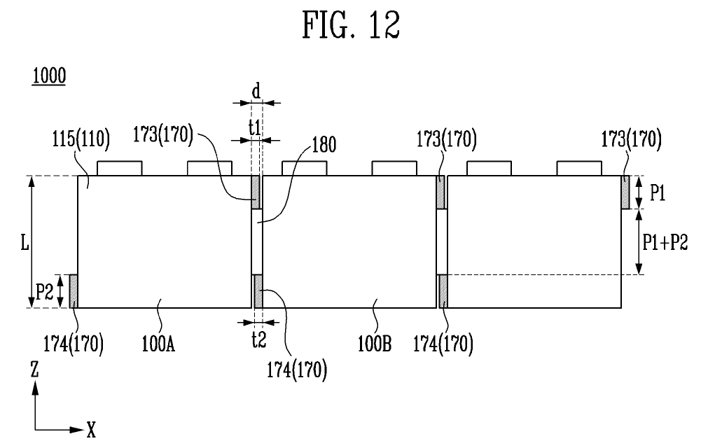

FIG. 12 illustrates another example of a battery system according to the present disclosure.

A battery system 1000 according to the present disclosure may include a plurality of battery stacking assembly 100, and an insertion 180 that is inserted between the plurality of battery stacking assembly 100 arranged along a stacking direction and a width direction perpendicular to the height direction.

According to the present disclosure, a battery system 1000 may comprise a first battery stacking assembly 110A and a second battery stacking assembly 110B, respectively, including a plurality of battery cells 110 arranged along a predetermined stacking direction, a first end portion 151 and a second end portion 152, each of which having a plate shape and disposed at an outermost side of the plurality of battery cells 110 along the stacking direction, and a first coupling member and a second coupling member integrally surrounding the plurality of battery cells 110, the first end portion 151, and the second end portion 152, wherein the first coupling member and the second coupling member, respectively, includes, a first band portion 173 extending along the stacking direction at a predetermined first height H1 along the height direction of the plurality of battery cells 110, a second band portion 174 extending along the stacking direction at a second height H2 lower than the first height H1 along the height direction of the plurality of battery cells 110, and a first tie portion 171 and a second tie portion 172, respectively, disposed opposite to the first end portion 151 and the second end portion 152 and connecting an end of the first band portion 173 and an end of the second band portion 174, and wherein the first battery stacking assembly 110A and the second battery stacking assembly 110B are arranged along a width direction perpendicular to the stacking direction and the height direction, and at least a portion of the first band portion 173 of the first battery stacking assembly 110A and the second band portion 174 of the second battery stacking assembly 110B are positioned to overlap each other.

For example, referring FIG. 3, a battery stacking assembly 100 according to the present disclosure comprises: a plurality of battery cells 110 disposed along a predetermined stacking direction; a plate shaped first end portion 151 and a second end portion 152 disposed at an outermost side of the plurality of battery cells 110 along the stacking direction; and a first battery stacking assembly 110A and a second battery stacking assembly 110B comprising a coupling member 170 integrally surrounding the plurality of battery cells 110, the first end portion 151, and the second end portion 152, wherein each of the first battery stacking assembly 110A and the second battery stacking assembly 110B includes a first band portion 173 extending along the stacking direction at a predetermined first height H1 set along a height direction of the plurality of battery cells 110; a second band portion 174 extending along the stacking direction at a second height H2 lower than the first height H1 along the height direction of the plurality of battery cells 110, and may include a first tie portion 171 and a second tie portion 172 disposed opposite to the first end portion 151 and the second end portion 152, respectively, connecting one end of the first band portion 173 with one end of the second band portion 174. Further, the first battery stacking assembly 110A and the second battery stacking assembly 110B may be arranged along a width direction perpendicular to the stacking direction and the height direction, such that at least a portion of the first band portion 173 of the first battery stacking assembly 110A and the second band portion 174 of the second battery stacking assembly 100 are positioned overlapping each other.

The plurality of battery stacking assembly 100 may be arranged along the width direction (X direction). Thus, the battery system 1000 may include a hollow space formed between a pair of adjacent battery stacking assembly 100 of the plurality of battery stacking assembly 100.

The insertion 180 may be disposed in the hollow space, i.e., the battery system 1000 according to the present disclosure may further comprise an insertion 180 inserted between a first band portion 173 of the first battery stacking assembly 110A and a second band portion 174 of the second battery stacking assembly 110B along the height direction.

The insertion 180 may include a flame-retardant or protective material. Further, the insertion 180 may include a shock-absorbing material. This can delay or prevent thermal propagation between the battery cells 110 and protect the battery cells 110 from shock and vibration.

Furthermore, the battery system 1000 may dispose cooling channels in the hollow space. This may improve the cooling performance of the battery system 1000.

There may be configurations that utilize the space, such as cooling channels. This may have the benefit of improving cooling performance, preventing heat propagation between cells during thermal propagation, and enhancing cell protection against shock.

Referring to FIG. 12, along the width direction, the gap d between the first battery stacking assembly 110A and the second battery stacking assembly 110B may be less than the sum of the thickness t1 of the first band portion 173 of the first battery stacking assembly 110A and the thickness t2 of the second band portion 174 of the second battery stacking assembly 110B.

The gap d between the first battery stacking assembly 110A and the second battery stacking assembly 110B may refer to a spacing between the case 115 of one of the battery cells 110 belonging to the first battery stacking assembly 110A and the case 115 of one of the battery cells 110 belonging to the second battery stacking assembly 110B that are adjacent to each other.

In other words, when the first battery stack 110A and the second battery stack 110B are arranged along the width direction, the coupling members 170 of the first battery stack 110A and the second battery stack 110B do not interfere with each other.

That is, the first band portion 173 of the first battery stacking assembly 110A and the second band portion 174 of the second battery stacking assembly 110B disposed opposite to each other of the coupling members 170 of the first battery stacking assembly 110A and the second battery stacking assembly 110B are disposed at different heights.

If the insertion 180 is removed, the gap between the first battery stacking assembly 110A and the second battery stacking assembly 110B may be determined by the thickness of the thicker of the first band portion 173 of the first battery stacking assembly 110A and the thickness of the second band portion 174 of the second battery stacking assembly 110B.

Further, each of the plurality of battery cells 110 may include a case 115 accommodating an electrode assembly therein, the sum of the length P1 of the first band portion 173 of the first battery stack 110A and the length P2 of the second band portion 174 of the second battery stack 110B, or the sum of the length P2 of the second band portion 174 of the first battery stack 110A and the length P1 of the first band portion 173 of the second battery stack 110B, may be less than or equal to half of the height L of the case 115 along the height direction.

This means that the length of the insertion 180 is at least the sum P1+P2 of the length P2 of the second band portion 174 of the first battery stacking assembly 110A and the length P1 of the first band portion 173 of the second battery stacking assembly 110B, so that the insertion 180 can sufficiently exert a protective, flameproof, or heat dissipating function.

The present disclosure may be practiced in various modifications and is not limited to the above-described embodiments. Therefore, if a modified embodiment includes components of the claims of the patent, it should be considered to be within the scope of the present disclosure.

What is claimed is:

1. A battery stacking assembly, comprising:
a plurality of battery cells arranged along a predetermined stacking direction;
a first end portion and a second end portion, each of which having a plate shape and disposed at an outermost side of the plurality of battery cells along the stacking direction; and
a coupling member integrally surrounding the plurality of battery cells, the first end portion, and the second end portion;
wherein the coupling member includes:
a first band portion extending along the stacking direction at a predetermined first height along the height direction of the plurality of battery cells;
a second band portion extending along the stacking direction at a second height lower than the first height along the height direction of the plurality of battery cells; and
a first tie portion and a second tie portion, respectively, disposed opposite to the first end portion and the second end portion and connecting an end of the first band portion and an end of the second band portion;
wherein the plurality of battery cells are disposed between the first band portion and the second band portion.

2. The battery stacking assembly according to claim 1, wherein the first end portion includes:
a contact surface, which is an outermost surface of the first end portion along the stacking direction;
a first side surface and a second side surface forming two side surfaces along a width direction perpendicular to the stacking direction and the height direction and contacting the first band portion and the second band portion, respectively; and
a top surface forming a top of the first end portion.

3. The battery stacking assembly according to claim 2, wherein a length of each of the plurality of battery cells along the width direction is less than or equal to a length of the first end portion.

4. The battery stacking assembly according to claim 2, wherein the first end portion includes:
a contact groove formed of a groove corresponding to a shape of the first tie portion on the contact surface for insertion of the first tie portion;
a first side groove formed of a groove corresponding to a shape of the first band portion and recessed along the width direction on the first side surface for insertion of the first band portion; and
a second side groove formed of a groove corresponding to a shape of the second band portion and recessed along the width direction on the second side surface for insertion of the second band portion.

5. The battery stacking assembly according to claim 2, wherein the first band portion includes:
a first band connection portion positioned on the first side surface and extending along the stacking direction; and a first band reinforcement portion positioned on the top surface, connected to the first band connection portion, surrounding an edge of the first end portion and extending along the stacking direction; and
wherein the first tie portion includes:
a first tie connection portion connected to the first band connection portion; and a first tie reinforcement portion connected to the first tie connection portion and the first band reinforcement portion.

6. The battery stacking assembly according to claim 5, wherein a length of the first band portion is different from a length of the second band portion along the height direction.

7. The battery stacking assembly according to claim 5, wherein the first band reinforcement portion is welded with the first band connection portion, and
wherein the first tie reinforcement portion is welded with the first band reinforcement.

8. The battery stacking assembly according to claim 5, wherein the first end portion further includes:
a contact groove formed of a groove corresponding to a shape of the first tie portion on the contact surface for insertion of the first tie portion;
a first side groove formed of a groove corresponding to a shape of the first band connection portion and recessed along the width direction on the first side surface for insertion of the first band connection portion;
a first top-side groove formed of a groove corresponding to a shape of the first band reinforcement portion on the top surface, recessed along the height direction, and connected to the first side groove for insertion of the first band reinforcement portion; and
a second side groove formed of a groove corresponding to a shape of the second band portion and recessed along the width direction on the second side surface for insertion of the second band portion.

9. The battery stacking assembly according to claim 8, wherein the first end portion further includes:
a first symmetrical groove formed on the first side surface with the same shape as the second side groove at a position corresponding to the second side groove;
a second symmetrical groove formed on the second side surface with the same shape as the first side groove at a position corresponding to the first side groove; and
a second top-side groove formed on the top surface with the same shape as the first top-side groove and connected to the second symmetrical groove.

10. The battery stacking assembly according to claim 2, wherein the first band portion includes:
a first band connection portion positioned on the first side surface and extending along the stacking direction; and a first band auxiliary portion positioned on the top surface and connected to the first band connection portion at a predetermined connection length along the stacking direction; and
wherein the first tie portion includes:
a first tie connection portion connected to the first band connection portion; and a first tie auxiliary portion connected to the first band auxiliary portion and the first tie connection portion.

11. The battery stacking assembly according to claim 10, wherein the first tie auxiliary portion is welded with the first band auxiliary portion.

12. The battery stacking assembly according to claim 2, wherein the first band portion includes:
a first band connection portion positioned on the first side surface and extending along the stacking direction; and a first band reinforcement portion positioned on the top surface, connected to the first band connection portion, surrounding an edge of the first end portion, and extending along the stacking direction; and
wherein the first tie portion includes:
a first tie connection portion connected to the first band connection portion; and a first tie auxiliary portion connected to the first band reinforcement portion and the first tie connection portion.

13. The battery stacking assembly according to claim 12, wherein the first tie auxiliary portion is welded with the first band reinforcement portion.

14. The battery stacking assembly according to claim 2, wherein the second band portion is in contact from the second height to a predetermined height along the height direction.

15. The battery stacking assembly according to claim 14, wherein the second height is the lowermost end of the second side surface.

16. The battery stacking assembly according to claim 2, wherein the coupling member further includes:
a first strap spaced apart from a bottom of the first band portion and extending along the stacking direction;
a second strap spaced apart from the top portion of the second band portion and extending along the stacking direction;
a first intersecting connection portion contacting the first end portion, connecting an end of the first strap to an end of the second strap, and intersecting the first tie portion; and
a second intersecting connection portion contacting the second end portion, connecting the other end of the first strap to the other end of the second strap, and intersecting the second tie portion.

17. A battery system comprises:
a first battery stacking assembly and a second battery stacking assembly, respectively, including a plurality of battery cells arranged along a predetermined stacking direction, a first end portion and a second end portion, each of which having a plate shape and disposed at an outermost side of the plurality of battery cells along the stacking direction, and a first coupling member and a second coupling member integrally surrounding the plurality of battery cells, the first end portion, and the second end portion;
wherein the first coupling member and the second coupling member, respectively, includes:
a first band portion extending along the stacking direction at a predetermined first height along the height direction of the plurality of battery cells;
a second band portion extending along the stacking direction at a second height lower than the first height along the height direction of the plurality of battery cells; and
a first tie portion and a second tie portion, respectively, disposed opposite to the first end portion and the second end portion and connecting an end of the first band portion and an end of the second band portion; and
wherein the first battery stacking assembly and the second battery stacking assembly are arranged along a width direction perpendicular to the stacking direction and the height direction, and at least a portion of the first band portion of the first battery stacking assembly and the second band portion of the second battery stacking assembly are positioned to overlap each other.

18. The battery system according to claim 17, further comprising:
an insertion inserted between the first band portion of the first battery stacking assembly and the second band portion of the second battery stacking assembly along the height direction.

19. The battery system according to claim 17, wherein a gap between the first battery stacking assembly and the second battery stacking assembly is less than the sum of a thicknesses of the first band portion of the first battery stacking assembly and the second band portion of the second battery stacking assembly along the width direction.

20. The battery system according to claim 17, wherein each of the plurality of battery cells includes a case accommodating an electrode assembly therein, and
wherein the sum of lengths of the first band portion of the first battery stacking assembly and the second band portion of the second battery stacking assembly or the sum of lengths of the second band portion of the first battery stacking assembly and the first band portion of the second battery stacking assembly is less than or equal to half the height of the case along the height direction.
